(19) United States
(12) Patent Application Publication
(10) Pub. No.: US 2021/0310412 A1
(43) Pub. Date: Oct. 7, 2021

(54) EXTERNAL AUXILIARY POWER UNIT

(71) Applicant: WILLIAMS INTERNATIONAL CO., L.L.C., Pontiac, MI (US)

(72) Inventors: Thomas J. WILLIAMS, Milford Township, MI (US); Jeffrey C. THOMPSON, Commerce Township, MI (US)

(73) Assignee: WILLIAMS INTERNATIONAL CO., L.L.C., Pontiac, MI (US)

(21) Appl. No.: 17/223,181

(22) Filed: Apr. 6, 2021

Related U.S. Application Data
(60) Provisional application No. 63/005,933, filed on Apr. 6, 2020.

(51) Int. Cl. F02C 7/20; B64D 41/00; B64D 29/00; B64D 37/00; B64D 27/10; F02C 6/20; H02K 7/18

(52) U.S. Cl. CPC F02C 7/20; B64D 41/00; B64D 29/00; B64D 37/005; F05D 2220/323; F02C 6/20; H02K 7/1823; B64D 2041/002; B64D 27/10

(57) ABSTRACT

A powerplant and a generator of an external auxiliary power unit (APU) are located within a nacelle that is mountable to a hardpoint of an aircraft via an associated a hardpoint attachment interface that provides for releasably coupling the external APU thereto, and provides for coupling a fuel supply of the aircraft to run the powerplant, and coupling electrical power from the external APU either to, or external of, the aircraft. The external auxiliary power unit (APU) incorporates a particulate filter in series with the inlet air flow to the powerplant.

### CROSS-REFERENCE TO RELATED APPLICATIONS

The instant application claims the benefit of prior U.S. Provisional Application Ser. No. 63/005,933 filed on 6 Apr. 2020, which is incorporated herein by reference in its entirety.

### BRIEF DESCRIPTION OF THE DRAWINGS

In the accompanying drawings:

FIG. 1 illustrates an external auxiliary power unit in cooperation with a military helicopter;

FIG. 2 illustrates a first partial cut-away isometric view of the external auxiliary power unit illustrated in FIG. 1;

FIG. 3 illustrates a second partial cut-away isometric view of the external auxiliary power unit illustrated in FIGS. 1 and 2;

FIG. 4 illustrates a side view of the external auxiliary power unit illustrated in FIGS. 1 through 3;

FIG. 5A illustrates a top view of the hardpoint attachment interface incorporated on the external auxiliary power unit illustrated in FIGS. 1 through 4;

FIG. 5B illustrates an alternative hardpoint attachment interface;

FIG. 6 illustrates a schematic block diagram of a first aspect of an external auxiliary power unit, incorporating a first embodiment of an associated gas turbine engine, and illustrates a first aspect of a particulate filter in cooperation with an associated powerplant;

FIG. 7 illustrates a schematic block diagram of the first aspect of the external auxiliary power unit, incorporating a second embodiment of the associated gas turbine engine in cooperation with a hydraulic starter;

FIG. 8 illustrates a schematic block diagram of the first aspect of the external auxiliary power unit, incorporating a second embodiment of the associated gas turbine engine in cooperation with an electric starter;

FIG. 9 illustrates a schematic block diagram of second and third aspects of an external auxiliary power unit, each incorporating the first embodiment of an associated gas turbine engine;

FIG. 10 illustrates a schematic block diagram of second and third aspects of an external auxiliary power unit, each incorporating the second embodiment of the associated gas turbine engine;

FIG. 11 illustrates a front view of the military helicopter illustrated in FIG. 1 incorporating an external auxiliary power unit;

FIG. 12 illustrates a bottom view of the military helicopter illustrated in FIGS. 1 and 11 incorporating an external auxiliary power unit;

FIG. 13 illustrates an external auxiliary power unit used for stationary power delivery;

FIGS. 14A and 14B illustrate an embodiment of an external auxiliary power unit that is configured with an external access panel incorporating externally-accessible connections that provide extracting power external of the external auxiliary power unit even with the external auxiliary power unit attached to an aircraft, with an associated access panel door closed in FIG. 14A and open in FIG. 14B; and

FIGS. 15A and 15B illustrate partial cut-away isometric views of an external auxiliary power unit incorporating a second aspect of a particulate filter in cooperation with the associated powerplant.

### DESCRIPTION OF EMBODIMENT(S)

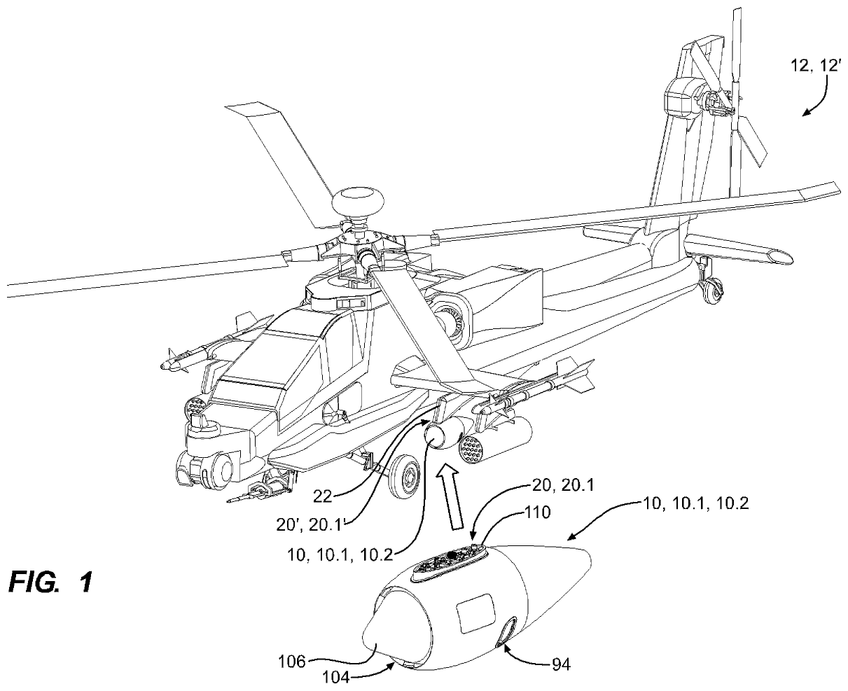

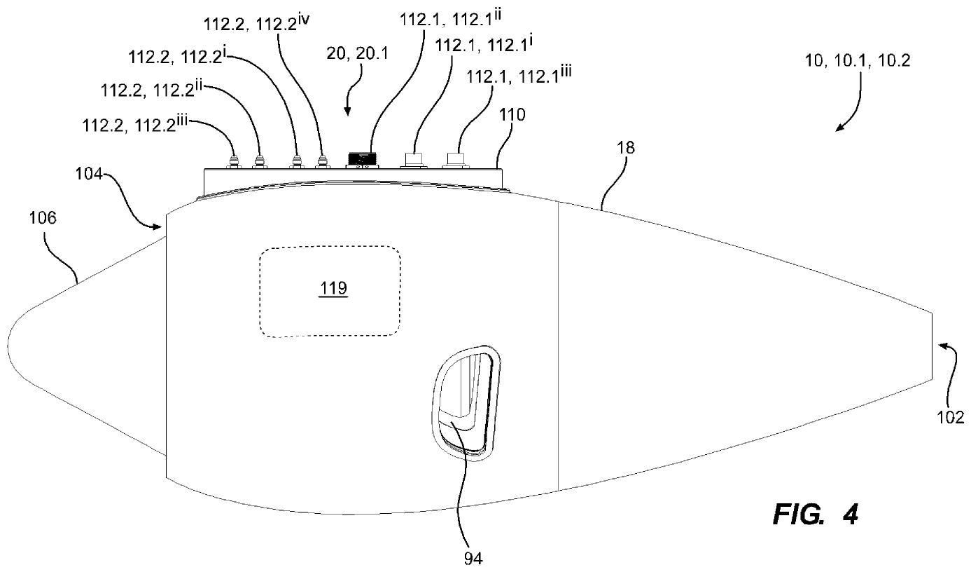

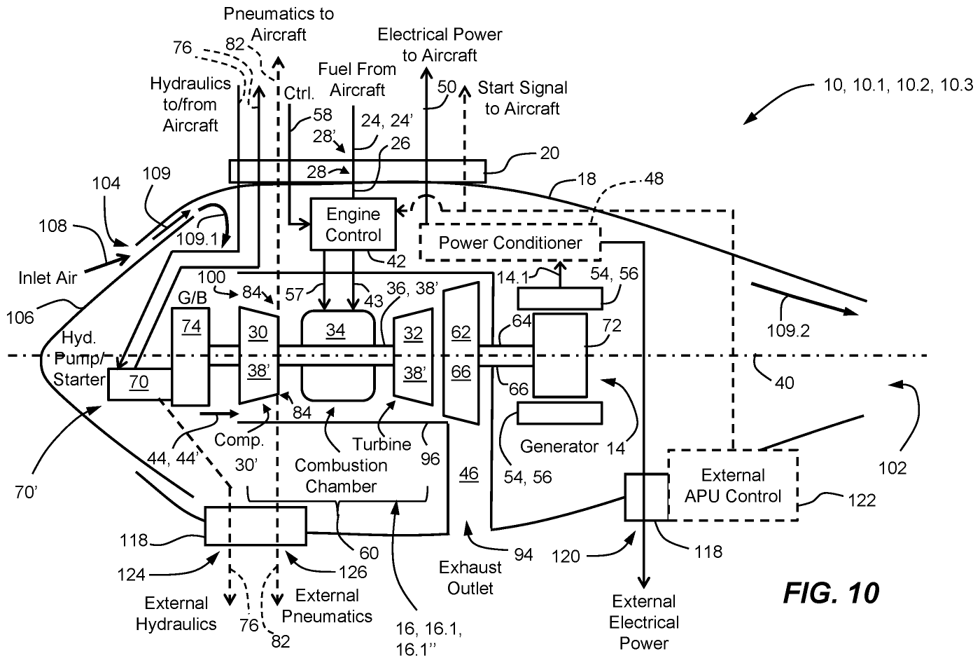

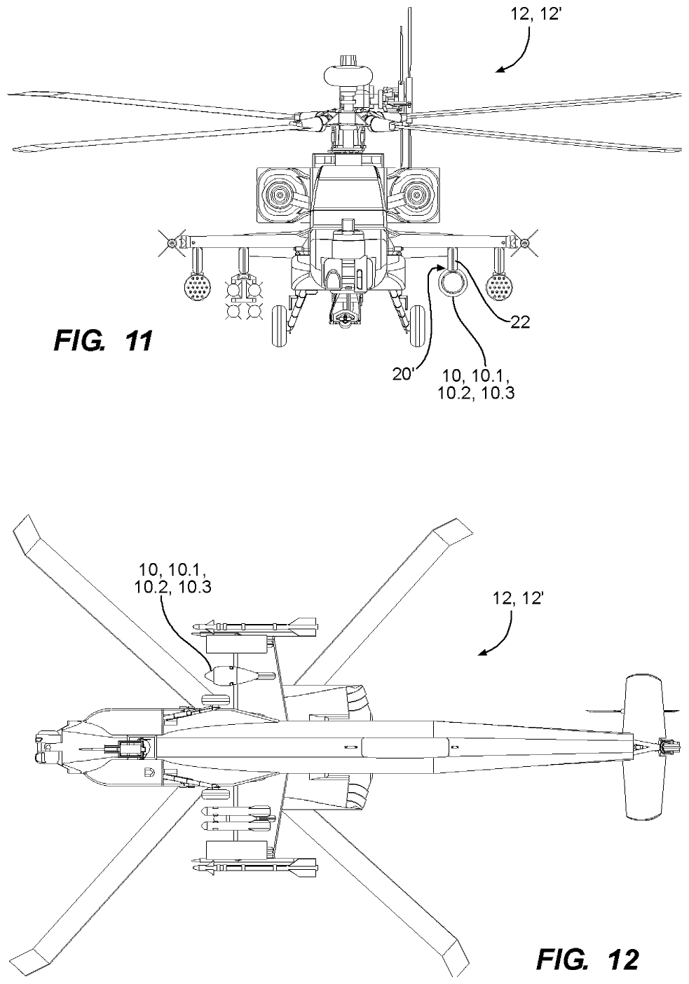

Referring to FIGS. 1 through 12, an external auxiliary power unit (APU) 10 is configured to be attached to an aircraft 12—for example, a military helicopter 12, 12′—for use therewith to provide power thereto as needed for a particular mission, or to be detached therefrom to provide for attaching a different payload to the aircraft 12, 12′ in support of a different mission. The external auxiliary power unit (APU) 10 incorporates an electrical generator 14 that is mechanically driven by an associated powerplant 16, both of which are housed in, and operatively coupled to, an associated externally-carried nacelle 18—for example, an aerodynamically-shaped nacelle 18, —the latter of which incorporates a hardpoint attachment interface 20 that provides for attaching to, and detaching from, an associated pylon 22 depending from the aircraft 12, 12′. The powerplant 16 runs on fuel 24 from the aircraft 12, 12′ that is supplied to the external auxiliary power unit (APU) 10 via an associated fuel line 26 having an associated fluid-conduit connector 28—also referred to as a fluid-port connector 28—either incorporated in, or depending from, the associated hardpoint attachment interface 20, and that is configured to releasably connect to a corresponding mating fluid-conduit connector 28′—also referred to as a mating fluid-port connector 28′—on the aircraft 12, 12′, for example, incorporated in a corresponding mating hardpoint attachment interface 20′ on the end of the pylon 22 of the aircraft 12, 12′.

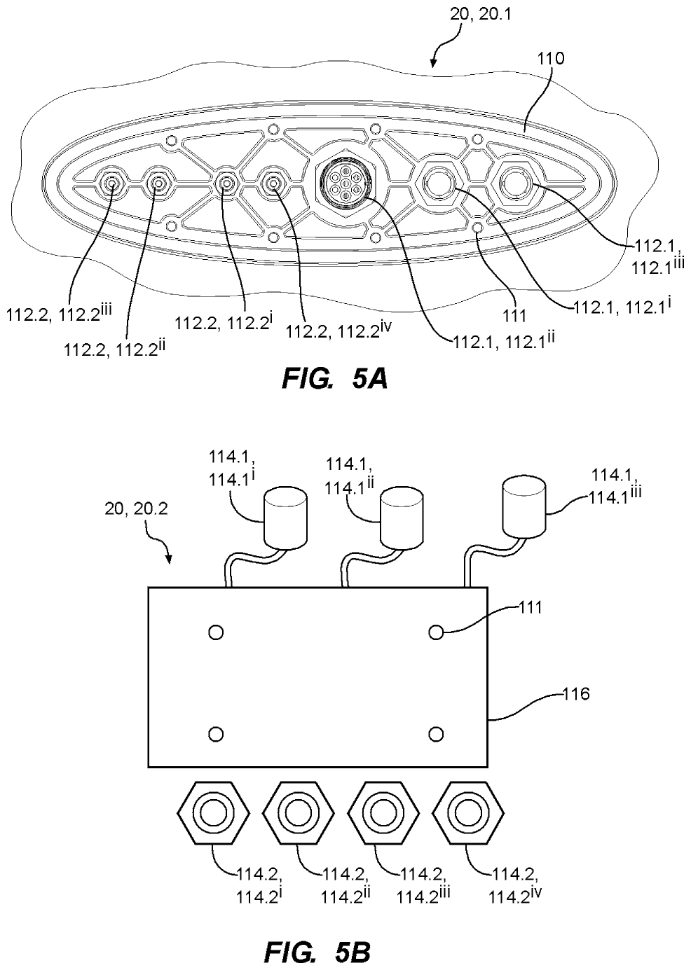

Referring to FIGS. 1-8, 11, 12 and 14A-15B, in accordance with a first aspect 10.1, the external auxiliary power unit (APU) 10, 10.1 is configured and used to exclusively supply power generated thereby to the aircraft 12, 12′, and is detachable therefrom responsive to the associated mission requirements. Referring to FIGS. 1-5B and 9-15B, in accordance with a second aspect 10.2, the external auxiliary power unit (APU) 10, 10.2 is detachable from the aircraft 12, 12′ responsive to the associated mission requirements, and is configured to either supply power generated thereby to the aircraft 12, 12′ directly, or to supply power external of the aircraft 12, 12′ either even while attached to the aircraft 12, 12′, or when detached therefrom and attached to a stationary frame and associated fuel supply. Referring to FIGS. 5A, 5B, 9-12, 14A and 14B, in accordance with a third aspect 10.3, the external auxiliary power unit (APU) 10, 10.3 is configured to either supply power generated thereby to the aircraft 12, 12′ directly, or to supply power external of the aircraft 12, 12′, but remains fixedly attached to the aircraft 12, 12′ except for maintenance, repair or replacement.

The powerplant 16 could be any type of powerplant that can operate on fuel 24 supplied by the aircraft 12, 12′, for example, either fuel 24 of the same type, for example, from the same supply tank or tanks, as is used for powering the aircraft 12, 12′, or fuel 24.1 that is carried by aircraft 12, 12′ but not otherwise used thereby. For example, in one set of embodiments, the external auxiliary power unit (APU) 10, 10.1, 10.2, 10.3 incorporates a gas turbine engine 16.1 for the associated powerplant 16, which runs on the same jet fuel 24′ as is also used to power the aircraft 12, 12′. Alternatively, the powerplant 16 could comprise an internal combustion engine, for example a diesel engine that either runs on the same type of fuel 24 as used to power the aircraft 12, 12′, or a different fuel 24.1, for example, diesel fuel 24.1′, that might be carried, but not otherwise used, by the aircraft 12, 12′.

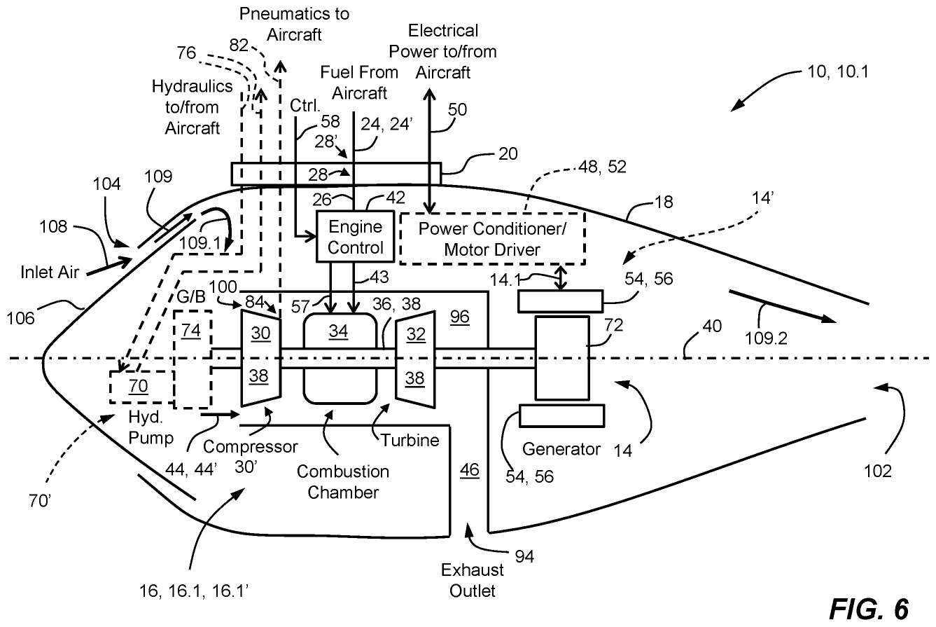

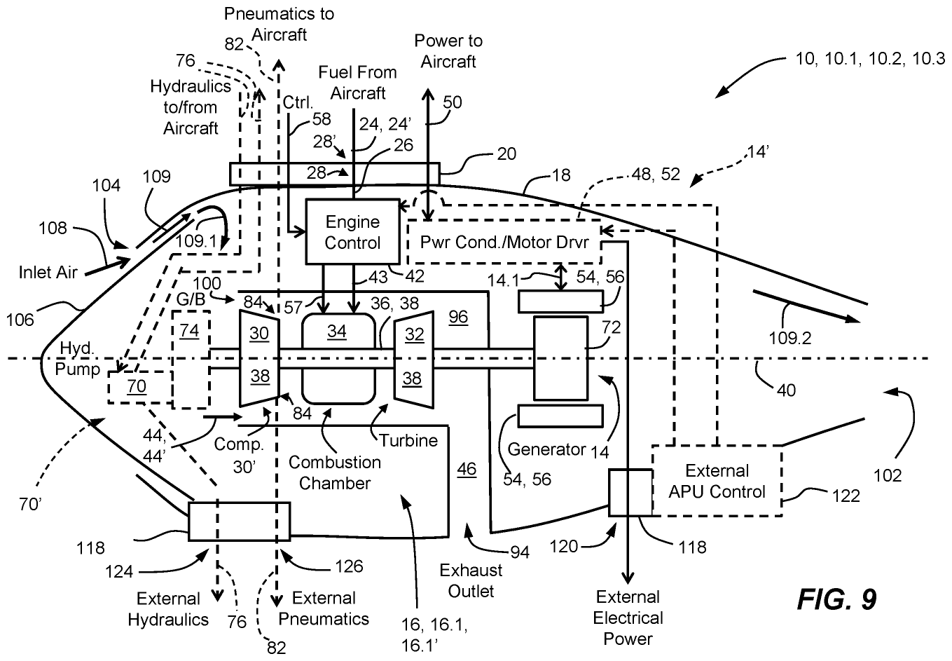

For example, referring to FIGS. 6 and 9, a first embodiment of the powerplant 16 comprises a single-spool gas turbine engine 16.1, 16.1′ incorporating compressor 30 and turbine 32 rotors—with a combustion chamber 34 located axially therebetween—that are interconnected by an associated shaft 36—collectively defining an associated spool 38—that provides for rotation of the associated spool 38 about an associated rotational axis 40. An associated engine control system 42 provides for controlling the injection of fuel 24, 24′ into the combustion chamber 34, wherein during operation of the single-spool gas turbine engine 16.1, 16.1′ in accordance with the Brayton cycle, fuel 24, 24′ injected into the combustion chamber 34—via an associated fuel-delivery system 43—under control of the engine control system 42 is combined with inlet air 44 that is pumped into the combustion chamber 34 by the blades of the compressor rotor 30, the latter of which is rotated by the turbine rotor 32 responsive to a flow of exhaust gases 46 from the combustion chamber 34 that flow across the blades of the turbine rotor 32 responsive to the combustion of the resulting mixture of fuel 24, 24′ and inlet air 44 in the combustion chamber 34.

In cooperation with the single-spool gas turbine engine 16.1, 16.1′ of the first embodiment powerplant 16, 16.1, the electrical generator 14 is directly coupled to, and rotated by, the spool 38 of the single-spool gas turbine engine 16.1, 16.1′ at the rotational speed thereof. The electrical generator 14 may comprise any type of electric-power-producing generator, for example, including, but not limited to, a permanent magnet generator (PMG), a homopolar hybrid permanent magnet generator (HHPMG), a switched reluctance generator, or an induction generator, or more generally, either an AC generator—synchronous or asynchronous—or a DC generator. The external auxiliary power unit (APU) 10, 10.1, 10.2, 10.3 may further incorporate a power conditioner 48, for example, to provide for changing the type—AC or DC—of power between the output 14.1 of the electrical generator 14 and that of the associated electrical power bus 50 of the aircraft 12, 12′, for example, so as to provide for converting the output 14.1 of an AC electrical generator 14 to a regulated DC voltage—for example, in one set of embodiments, 270 VDC—to supply the electrical power bus 50 of the aircraft 12, 12′. Generally, the power conditioner 48 could provide for one or more of a) converting from AC to DC using a rectifier, b) converting DC to AC using an inverter—single or multi-phase, c) regulating the magnitude of the output voltage using a voltage regulator, or d) filtering the output power signal using an electrical filter. Furthermore, with the electrical generator 14 directly coupled to the spool 38 of the single-spool gas turbine engine 16.1, 16.1′, the electrical generator 14 may be operated in an electrical motor mode 14′ to provide for starting the single-spool gas turbine engine 16.1, 16.1′ using electrical power—either AC or DC—from an electrical power bus 50 of the aircraft 12, 12′, via an associated motor driver 52.

Accordingly, in accordance with a first embodiment of an associated starting system, the external auxiliary power unit (APU) 10, 10.1, 10.2, 10.3 incorporates a motor driver 52 that converts the electrical power—either AC or DC—from an electrical power bus 50 of the aircraft 12, 12′ to corresponding drive signals to a sufficient number of the coils 54 of the stator 56 of the electrical generator 14 operated in an electrical motor mode 14′ so as to provide for rotating the spool 38 of the single-spool gas turbine engine 16.1, 16.1′ during startup, until there is sufficient air flow from the compressor rotor 30 through the combustion chamber 34 for the engine control system 42 to commence injecting fuel 24, 24′ therein and for the ignition thereof by an ignition signal 57 responsive to an APU start/stop control signal 58.

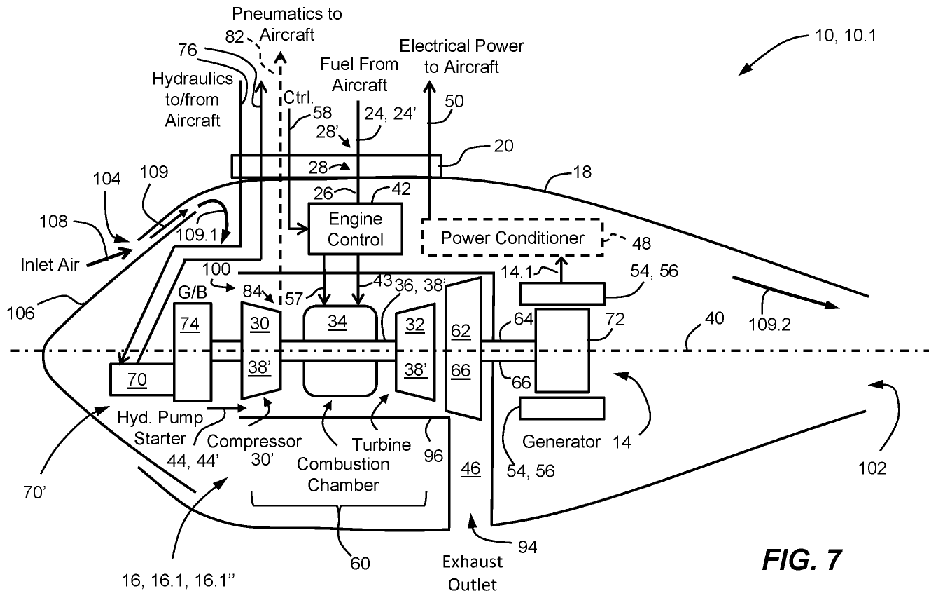

As another example, referring to FIGS. 7, 8 and 10, a second embodiment of the powerplant 16 comprises a dual-spool gas turbine engine 16.1, 16.1″ incorporating compressor 30 and turbine 32 rotors and an interconnecting shaft 36 as a first spool 38′ spanning an associated combustion chamber 34, similar to that of the above-described single-spool gas turbine engine 16.1, 16.1′, but collectively configured as a gas generator 60, with load on the turbine rotor 32 being substantially limited to only that associated with driving the compressor rotor 30 and related mechanical parasitics and pumping losses, and to that associated with driving an associated below-described hydraulic oil pump 70 if the external auxiliary power unit (APU) 10, 10.1, 10.2, 10.3 incorporates a hydraulic oil pump 70 operatively coupled to the first spool 38′ of the dual-spool gas turbine engine 16.1, 16.1″. A power turbine 62 and associated shaft 64—collectively constitute a second spool 66—for example, in one set of embodiments, sharing the same rotational axis 40 as the first spool 38′. During operation, exhaust gases 46—generated by the gas generator 60 operating in accordance with the Brayton cycle as described hereinabove for the single-spool gas turbine engine 16.1, 16.1′—impinge upon the blades of the power turbine 62, causing a rotation thereof and associated mechanical power transfer thereto, which in turn drives an electrical generator 14, the rotor 72 of which is directly coupled to the second spool 66 of the dual-spool gas turbine engine 16.1, 16.1″.

Referring to FIGS. 6-10, if the aircraft 12, 12′ incorporates a DC electrical power bus 50, in one set of embodiments, the external auxiliary power unit (APU) 10, 10.1, 10.2, 10.3 may incorporate a power conditioner 48 to provide for converting AC power from an AC electrical generator 14 to regulated DC power output to the electrical power bus 50. If the aircraft 12, 12′ incorporates an AC electrical power bus 50, in one set of embodiments, AC power from an AC electrical generator 14 is output directly therefrom to the electrical power bus 50 of the aircraft 12, 12′, either without need for an associated power conditioner 48, or using an associated power conditioner 48 to generate a controlled AC output, for example, in one set of embodiments, by first converting the AC output of the AC electrical generator 14 to a rectified DC power signal using a rectifier and possibly a filter, and then using that rectified/filtered DC power signal as input to an inverter to provide for generating a controlled AC output power signal—either single phase or multi-phase.

Referring to FIGS. 6, 7, 9 and 10, the external auxiliary power unit (APU) 10, 10.1, 10.2, 10.3 may incorporate a hydraulic oil pump 70 that is operatively coupled to either the spool 38 of the single-spool gas turbine engine 16.1, 16.1′, or to the rotor 72 of the electrical generator 14, via an associated gearbox 74 so as to provide for generating hydraulic power for use by the aircraft 12, 12′, wherein the hydraulic oil pump 70 provides for pumping and pressurizing hydraulic fluid 76 from a supply thereof in the aircraft 12, 12′.

When a hydraulic oil pump 70 is operatively coupled to either the spool 38 of the first embodiment powerplant 16, 16.1′, or to the first spool 38′ of the second embodiment powerplant 16, 16.1″, in accordance with a second embodiment of an associated starting system, the hydraulic oil pump 70 may be operated in a hydraulic motor mode 70′ responsive to hydraulic pressure and flow from the aircraft 12, 12′, so as to provide for rotating either the spool 38 of the single-spool gas turbine engine 16.1, 16.1′, or the first spool 38′ of the second embodiment powerplant 16, 16.1″, during startup, followed by fuel injection and ignition as described hereinabove.

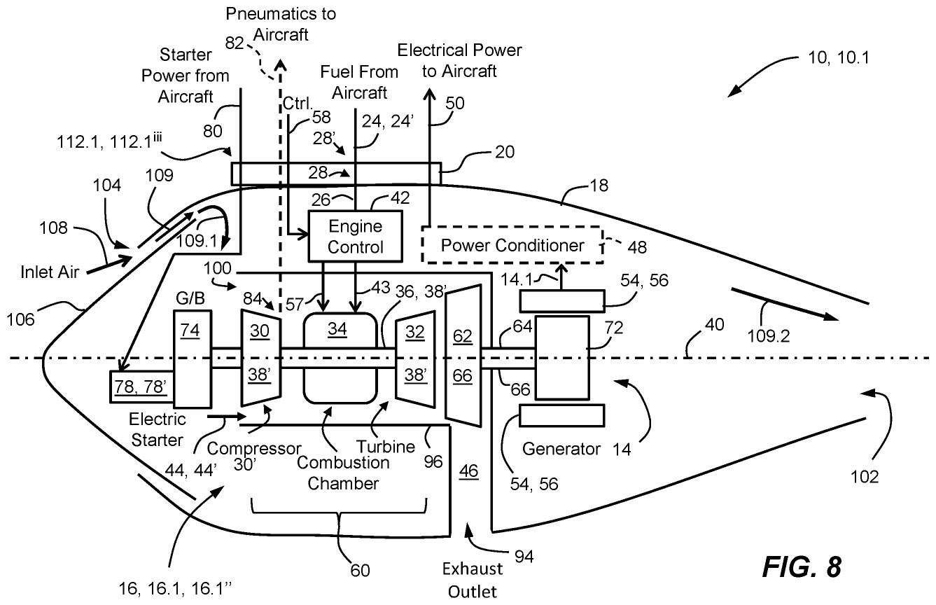

Referring to FIG. 8, in accordance with a third embodiment of an associated starting system, the external auxiliary power unit (APU) 10, 10.1, 10.2, 10.3 incorporates a starter motor 78—for example, a DC motor 78′ that is either brushless or not—that is operatively coupled to the first spool 38′ of the second embodiment powerplant 16, 16.1″ (or optionally to the spool 38 of a first embodiment powerplant 16, 16.1′), either directly or via an associated gearbox 74, wherein the starter motor 78 is powered from an associated drive signal 80 from the aircraft 12, 12′. Alternatively, in one set of embodiments, the starter motor 78 may be powered from a battery incorporated in the external auxiliary power unit (APU) 10, 10.1, 10.2, 10.3.

Referring to FIGS. 6-10, the external auxiliary power unit (APU) 10, 10.1, 10.2, 10.3 may be configured to provide pneumatic power 82 to the aircraft 12, 12′, for example, wherein the pneumatic power 82 may be extracted via a bleed port 84 from the compressor 30′ of the gas turbine engine 16.1, 16.1′, 16.1″, or from a separate air pump or compressor that is operatively coupled to—either directly or via an associated gearbox—and driven by the powerplant 16.

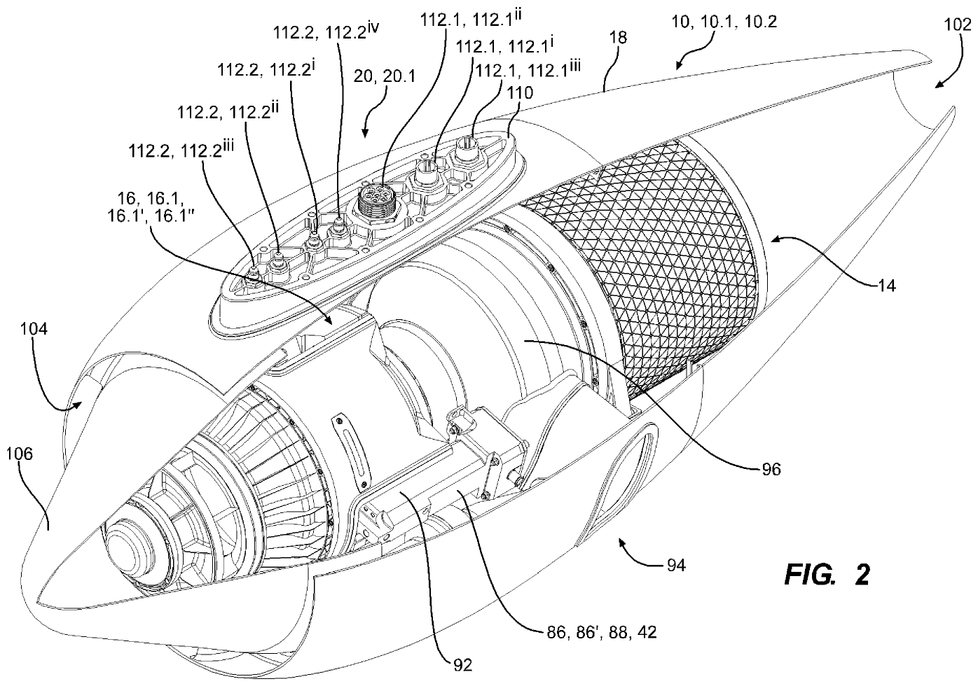

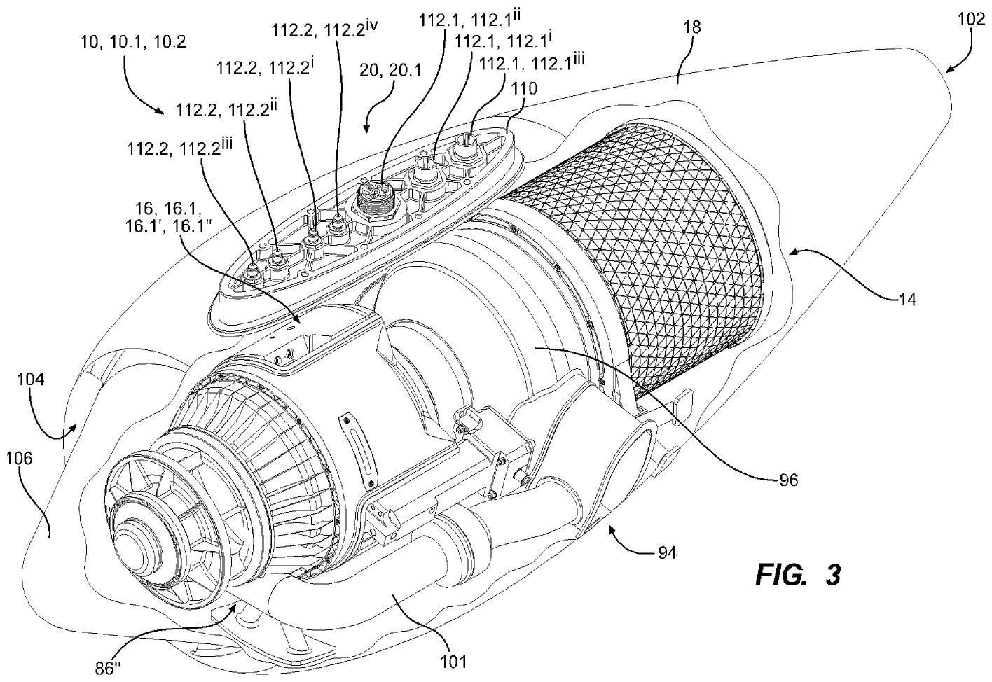

Referring to FIGS. 2 and 3, in one set of embodiments, the gas turbine engine 16.1, 16.1′, 16.1″ incorporates a lubrication system 86—including an associated oil tank 86′, —a fuel delivery system 88, and the engine control system 42, components of which are housed in a housing 92, for example, centrally located along, and operatively coupled to, a side of the gas turbine engine 16.1, 16.1′, 16.1″.

Referring to FIGS. 1-4 and 6-10, in one set of embodiments, the gas turbine engine 16.1, 16.1′, 16.1″ further incorporates at least one exhaust outlet duct 94 that extends at-least-partially radially outwards from an internal exhaust duct 96 of the gas turbine engine 16.1, 16.1′, 16.1″ surrounding the associated turbine rotor 32 or power turbine 62, to and through the side of the nacelle 18, so as to provide for discharging exhaust gases 46 out of the side of the nacelle 18 of the external auxiliary power unit (APU) 10, 10.1, 10.2, 10.3.

Referring to FIG. 3, in one set of embodiments, the gas turbine engine 16.1, 16.1′, 16.1″ incorporates an oil cooler 86″ that is configured to be cooled either, or both, with bleed air from the compressor 30′, or, referring also to FIGS. 6-10, with at least a portion of the inlet air flow 44′ that flows into the air inlet duct 100 of the gas turbine engine 16.1, 16.1′, 16.1″, for example, so as to provide for cooling the gas turbine engine 16.1, 16.1′, 16.1″ when statically operated on the ground, wherein the bypass air flow discharged from the oil cooler 86″ is then discharged through a pipe 101 that discharges into the associated exhaust outlet duct 94 of the external auxiliary power unit (APU) 10, 10.1, 10.2, 10.3. Alternatively, the bypass air flow discharged from the oil cooler 86″ could be discharged from the external auxiliary power unit (APU) 10, 10.1, 10.2, 10.3 though a bay vent 102 at the tail end of the nacelle 18. When adapted to be cooled with at least a portion of the inlet air flow 44′ that flows into the air inlet duct 100 of the gas turbine engine 16.1, 16.1′, 16.1″, the oil cooler 86″ can provide for heating the inlet air flow 44′ into the compressor 30′ so as to prevent, or mitigate against, icing during operation of the gas turbine engine 16.1, 16.1′, 16.1″, for example, during flight of the aircraft 12, 12′.

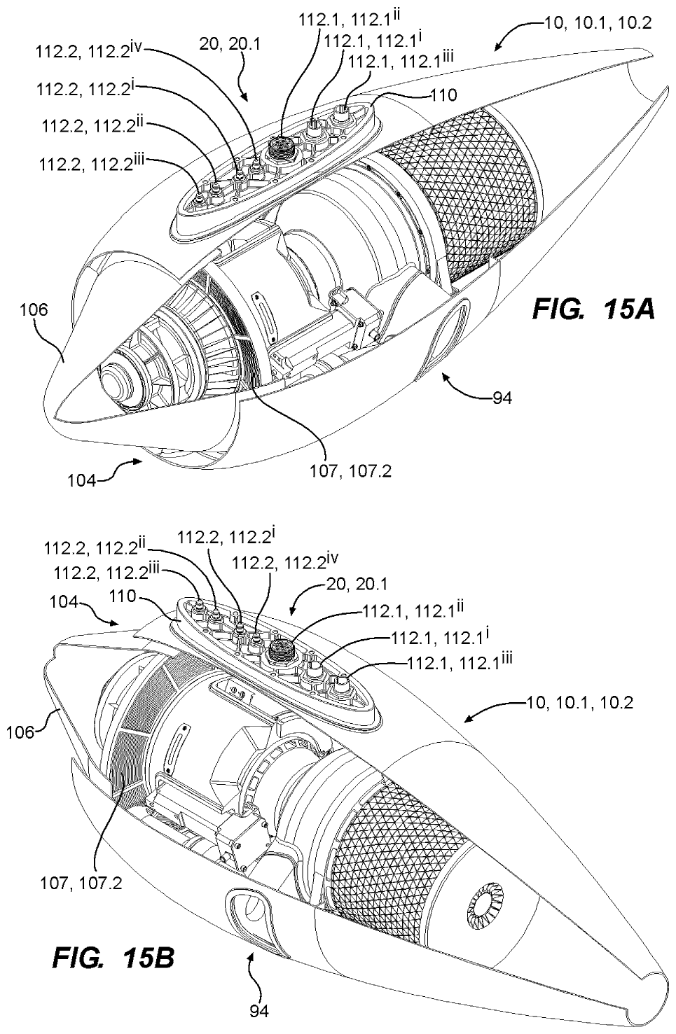

Referring to FIGS. 1-4 and 6-10, in one set of embodiments, the nacelle 18 incorporates an annular air-inlet-duct 104 in cooperation with a domed conical-inlet-air-deflector 106 that provides for directing an associated initially-aftwardly-flowing inlet air stream 108 radially-outwards into the annular air-inlet-duct 104. Then, in accordance with a first aspect 107.1 of a particulate filter 107, 107.1, after entering the inside of the nacelle 18, a substantial first portion 109.1 of the inlet air flow 109 follows an at least partially tortuous path into the entrance of the air inlet duct 100 of the gas turbine engine 16.1, 16.1′, 16.1″ as the inlet air flow 44′ thereinto. A remaining second portion 109.2 of the inlet air flow 109 that is not ingested by the gas turbine engine 16.1, 16.1′, 16.1″ is free to travel within and along the inside of the nacelle 18 and provide for cooling the outsides of the gas turbine engine 16.1, 16.1′, 16.1″ and electrical generator 14 before being discharged through the bay vent 102 at the tail end of the nacelle 18. The centrifugal acceleration of the first portion 109.1 of the inlet air flow 109 flowing from the outlet of the annular air-inlet-duct 104 to the entrance of the air inlet duct 100 of the gas turbine engine 16.1, 16.1′, 16.1″ provides for inertially separating particles from the inlet air stream 108 so as to preclude, or mitigate against, the ingestion thereof by the gas turbine engine 16.1, 16.1′, 16.1″, with the separated particles instead being carried by the second portion 109.2 of the inlet air flow 109 that is ultimately discharged from the bay vent 102 at the tail end of the nacelle 18. Referring to FIGS. 15A-15B, alternatively, or additionally, in accordance with a second aspect 107.2 of an associated particulate filter 107, 107.2, an air filter 107.2 incorporating an associated filter media may be located within or upstream of an the air inlet duct 100 of the gas turbine engine 16.1, 16.1′, 16.1″ to filter out particulates from the first portion 109.1 of the inlet air flow 109 ingested by the gas turbine engine 16.1, 16.1′, 16.1″. Further alternatively, or in addition to at least one of the first 107.1 and second 107.2 aspect particulate filters 107, in accordance with a third aspect of a particulate filter 107, the annular air-inlet-duct 104 may incorporate inlet guide vanes that provide for inducing swirl in the inlet air stream 108 so as to provide for inertial particle separation responsive to a circumferential component of flow induced thereby with rotation about a longitudinal axis of the annular air-inlet-duct 104, wherein, for example, in one set of embodiments, the longitudinal axis of the annular air-inlet-duct 104 is aligned with the rotational axis 40 of the associated gas turbine engine 16.1, 16.1′, 16.1″.

Referring to FIGS. 1-5A and 13-15B, in accordance with a first embodiment, the hardpoint attachment interface 20, 20.1 incorporates a truncated pylon structure 110 that is rigidly coupled to the nacelle 18, and either directly, or indirectly, rigidly coupled to the gas turbine engine 16.1, 16.1′, 16.1″, so as to provide for rigidly attaching the nacelle 18, the gas turbine engine 16.1, 16.1′, 16.1″, and the electrical generator 14 to the aircraft 12, 12′, for example, via a plurality of bolts (not illustrated) from the pylon 22 of the aircraft 12, 12′ that engage with a corresponding set of threaded holes 111 in the truncated pylon structure 110. The first embodiment hardpoint attachment interface 20, 20.1 further incorporates a plurality of electrical 112.1 and fluid-conduit 112.2 connector portions—also respectively referred to as electrical-port 112.1 and fluid-port 112.2 connectors—within the truncated pylon structure 110 that are configured to operatively engage with corresponding mating connector portions in a corresponding mating hardpoint attachment interface 20′, 20.1′ depending from the associated pylon 22 of the aircraft 12, 12′. For example, in accordance with one set of embodiments, the electrical 112.1 and fluid-conduit 112.2 connector portions include a fuel supply connector portion 112.2ⁱ, an electrical power connector portion 112.1ⁱ and a multi-channel communications connector portion 112.1ⁱⁱ, the latter of which might include terminals that provide carrying signals for starting and running the powerplant 16, 16.1, 16.1′, 16.1″, and possibly signals for monitoring the health thereof, for example, oil pressure, oil temperature, or other temperatures or pressures specific to the particular type of powerplant 16, 16.1, 16.1′, 16.1″. Furthermore, depending upon the configuration of the external auxiliary power unit (APU) 10, 10.1, 10.2, 10.3, the electrical 112.1 and fluid-conduit 112.2 connector portions might also include one or more of a hydraulic inlet connector portion 112.2ⁱⁱ, a hydraulic outlet connector portion 112.2ⁱⁱⁱ (collectively schematically illustrated in FIGS. 6, 7, 9 and 10, and further illustrated in FIGS. 2-4, 5A and 14A-15B), a pneumatic outlet connector portion 112.2^{iv} (schematically illustrated in FIGS. 6-10, and further illustrated in FIGS. 1-5A and 13-15B), and a starting-power connector portion 112.1ⁱⁱⁱ (schematically illustrated in FIG. 8, and further illustrated in FIGS. 1-5A and 14A-15B). Alternatively, for purposes of starting an external auxiliary power unit (APU) 10, 10.1, 10.2, 10.3 that either incorporates a starter motor 78 or for which powerplant 16 can be started using the electrical generator 14 operated in an electrical motor mode 14′, instead of utilizing a separate starting-power connector portion 112.1ⁱⁱⁱ, the external auxiliary power unit (APU) 10, 10.1, 10.2, 10.3 may be configured—e.g. with an internal controller—to provide for utilizing the electrical power connector portion 112.1′ to receive electrical power to power either the starter motor 78 or electrical generator 14 operated in an electrical motor mode 14′, and after the powerplant 16 has been started, to provide for utilizing the electrical power connector portion 112.1ⁱ to supply electrical power that is generated by the electrical generator 14. Furthermore, in one set of embodiments, rather than a designated starting-power connector portion 112.1ⁱⁱⁱ, a third electrical connector portion 112.1ⁱⁱⁱ could be configured either as a starting-power connector portion 112.1ⁱⁱⁱ to receive electrical power to starting the external auxiliary power unit (APU) 10, 10.2, or as an electrical connector to provide conditioned electrical output power from the external auxiliary power unit (APU) 10, 10.2.

The hardpoint attachment interface 20, 20.1 is configured to conform to the mating hardpoint attachment interface 20′, 20.1′ that can otherwise also be used by the aircraft 12, 12′ to carry other payloads, including, but not limited to, a detachable external fuel tank, detachable external munitions, a detachable external weapons system, or a detachable external reconnaissance system, so as to provide for the external auxiliary power unit (APU) 10, 10.1, 10.2 to be interchangeable therewith.

Referring to FIG. 5B, in accordance with a second embodiment of a hardpoint attachment interface 20, 20.2, the associated electrical 114.1 and fluid-conduit 114.2 connector portions are independent of the associated structural mount portion 116, the latter of which provides for rigid attachment of the external auxiliary power unit (APU) 10, 10.1, 10.2, 10.3 to a corresponding mating portion on a pylon 22 of the aircraft 12, 12′. For example, in accordance with one set of embodiments, the electrical 114.1 and fluid-conduit 114.2 connector portions include a fuel supply connector portion 114.2ⁱ, an electrical power connector portion 114.1ⁱ and a multi-channel communications connector portion 114.1ⁱⁱ, the latter of which might include terminals that provide carrying signals for starting and running the powerplant 16, 16.1, 16.1′, 16.1″, and possibly signals for monitoring the health thereof, for example, oil pressure, oil temperature, or other temperatures or pressures specific to the particular type of powerplant 16, 16.1, 16.1′, 16.1″. Furthermore, depending upon the configuration of the external auxiliary power unit (APU) 10, 10.1, 10.2, 10.3, the electrical 114.1 and fluid-conduit 114.2 connector portions might also include one or more of a hydraulic inlet connector portion 114.2ⁱⁱ, a hydraulic outlet connector portion 114.2ⁱⁱⁱ, a pneumatic outlet connector portion 114.2^{iv}, and a starting-power connector portion 114.1ⁱⁱⁱ.

Referring to FIGS. 9, 10, 14A and 14B, in accordance with the second aspect 10.2, the external auxiliary power unit (APU) 10, 10.2 incorporates an additional external interface 118 external of the aircraft 12, 12′, which provides for external access to power generated by the external auxiliary power unit (APU) 10, 10.2. For example, in one set of embodiments, the external interface 118 incorporates an externally-accessible electrical power connector socket 120 to provide for accessing power from the ground. For example, in one scenario, an aircraft 12, 12′ equipped with an external auxiliary power unit (APU) 10, 10.2 could be flown into a remote camp to provide for delivering electrical power to the camp from the external auxiliary power unit (APU) 10, 10.2 after the associated powerplant 16, 16.1, 16.1′, 16.1″ is started. Depending upon the configuration of the external auxiliary power unit (APU) 10, 10.2, the powerplant 16, 16.1, 16.1′, 16.1″ thereof would be started using either electrical or hydraulic power from the aircraft 12, 12′, or started independently of the aircraft 12, 12′ if the external auxiliary power unit (APU) 10, 10.2 is equipped with a battery, with starting under control of an external APU control interface 122. In either case, the running powerplant 16, 16.1, 16.1′, 16.1″ would continue to deliver power to the camp even with the powerplant of the aircraft 12, 12′ shut down, provided that the aircraft 12, 12′ is configured to continue to supply fuel 24, 24′ to the external auxiliary power unit (APU) 10, 10.2 either by gravity feed, or via a fuel pump powered by the external auxiliary power unit (APU) 10, 10.2. Depending upon the configuration thereof, the external auxiliary power unit (APU) 10, 10.2 could also be configured to provide external hydraulic or pneumatic a power for use on the ground via corresponding externally-accessible hydraulic 124 or pneumatic 126 fluid-conduit connector sockets, respectively.

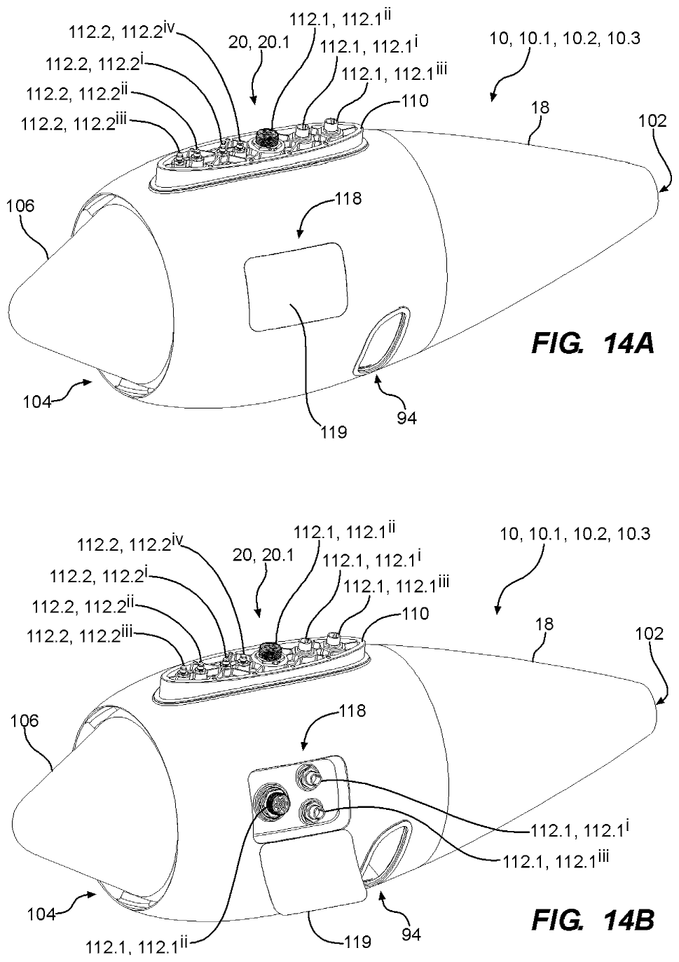

For example, referring to FIGS. 14A and 14B, in one set of embodiments, the external interface 118 is accessible via a door 119 on the outside of the nacelle 18 that provides access to an associated multi-channel communications connector portion 112.1ⁱⁱ, electrical power connector portion 112.1ⁱ, and a third electrical connector portion 112.1ⁱⁱⁱ, the latter of which could be configured either as a starting-power connector portion 112.1ⁱⁱⁱ to receive electrical power to starting the external auxiliary power unit (APU) 10, 10.2, or as a electrical connector to provide conditioned electrical output power from the external auxiliary power unit (APU) 10, 10.2. Alternatively, the external interface 118 could also incorporate either, or both, a pneumatic outlet connector portion 112.2^{iv}, or a set of hydraulic inlet 112.2ⁱⁱ and outlet 112.2ⁱⁱⁱ connector portions. Accordingly, with the aircraft 12, 12′ parked on the ground, the second aspect 10.2, the external auxiliary power unit (APU) 10, 10.2 can provide power external of the aircraft 12, 12′ regardless of whether or not the aircraft 12, 12′ is running, wherein the external auxiliary power unit (APU) 10, 10.2 can be started by ground personnel external of the aircraft 12, 12′ responsive to a control signal via the multi-channel communications connector portion 112.1ⁱⁱ, and then run on fuel 24 supplied by the aircraft 12, 12′.

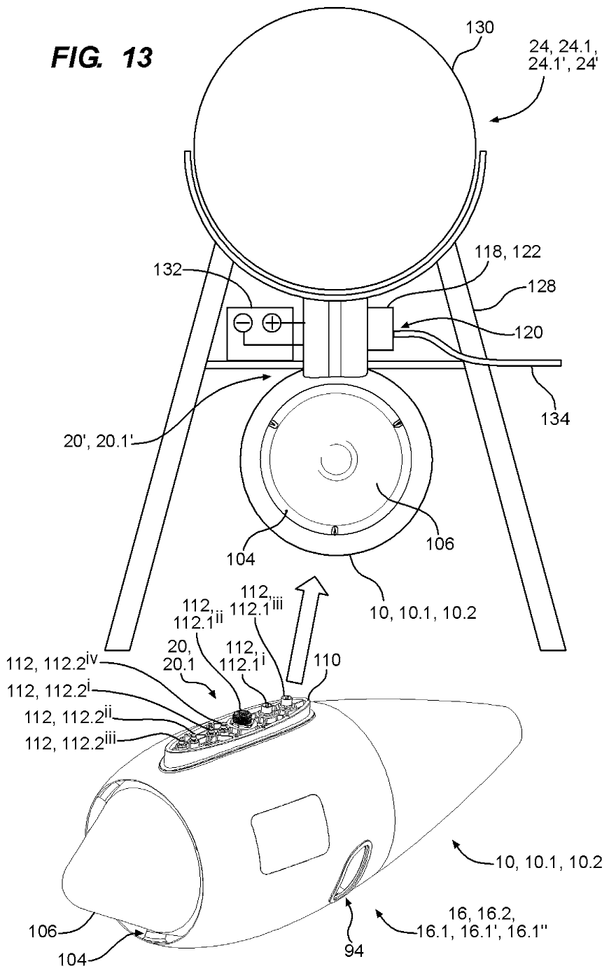

Referring to FIG. 13, once flown to a stationary location, in accordance with one set of embodiments, the second aspect external auxiliary power unit (APU) 10, 10.2 can be disconnected from the aircraft 12, 12′ and reconnected to a stationary frame 128 that incorporates a fuel tank 130 and—if not otherwise already incorporated in the second aspect external auxiliary power unit (APU) 10, 10.2—a battery 132 to provide for starting the associated powerplant 16 for a second aspect external auxiliary power unit (APU) 10, 10.2 that either incorporates a starter motor 78 or for which powerplant 16 can be started using the electrical generator 14 operated in an electrical motor mode 14′, or for providing power for associated control signals. Alternatively, or additionally, the stationary frame 128 could incorporated a hydraulic power supply—for example, electric-motor driven, and in one set of embodiments, incorporating a hydraulic accumulator to provide for sufficient peak hydraulic power sufficient to start the powerplant 16—to provide for driving a hydraulic motor (e.g. a hydraulic oil pump 70 operating in a hydraulic motor mode 70′) for starting the powerplant 16. For example, in one set of embodiments, the associated powerplant 16 could comprise a diesel engine 16.2 so as to provide for the use of relatively-more-economical diesel fuel 24.1′ that could be either flown or trucked in to fill or refill the fuel tank 130 at a remote location where the second aspect external auxiliary power unit (APU) 10, 10.2 is to be used. Alternatively, a second aspect external auxiliary power unit (APU) 10, 10.2 incorporating a gas turbine engine 16.1, 16.1′, 16.1″ could be similarly used in cooperation with the stationary frame 128, but with associated fuel tank 130 filled with jet fuel 24′. In operation, with the powerplant 16, 16.2, 16.1, 16.1′, 16.1″ running on fuel 24, 24.1, 24.1′, 24′ supplied form the fuel tank 130 on the stationary frame 128 supporting the second aspect external auxiliary power unit (APU) 10, 10.2 under control via an associated external APU control interface 122, the associated electrical generator 14 provides electrical power via an associated external interface 118 to an associated external power cable 134 that is plugged into the externally-accessible electrical power connector socket 120 of the external interface 118. The external interface 118 may also incorporate a set of hydraulic inlet 112.2ⁱⁱ and outlet 112.2ⁱⁱⁱ connector portions to provide external access to hydraulic power from a second aspect external auxiliary power unit (APU) 10, 10.2 incorporating a hydraulic oil pump 70.

Referring to FIGS. 9-12, 14A and 14B, in accordance with the third aspect 10.3, the external auxiliary power unit (APU) 10, 10.3 could be configured the same as the above-described second aspect external auxiliary power unit (APU) 10, 10.2, but remain fixedly attached to the aircraft 12, 12′, thereby precluding a need for an associated hardpoint attachment interface 20 that might otherwise be readily detachable from the aircraft 12, 12′, but configured to either to provide for generating supplemental power for the aircraft 12, 12′, or to provide for generating readily accessible power for use external of the aircraft 12, 12′.

It should be understood that the electrical generator 14 can be coupled via a gearbox to either the spool 38 of the single-spool gas turbine engine 16.1, 16.1′, or to the second spool 66 of the dual-spool gas turbine engine 16.1, 16.1″.

It should be further understood that for an external auxiliary power unit (APU) 10, 10.1, 10.2, 10.3 incorporating a hydraulic oil pump 70, the hydraulic oil pump 70/gearbox 74 can be coupled to either end of spool 38 of single-spool gas turbine engine 16.1, 16.1′, to the second spool 66 of the dual-spool gas turbine engine 16.1, 16.1″, or to the rotor 72 of the electrical generator 14.

It should be yet further understood that for an external auxiliary power unit (APU) 10, 10.1, 10.2, 10.3 incorporating a single-spool gas turbine engine 16.1, 16.1′, a starter motor 78/gearbox 74 could be coupled to either end of the spool 38 thereof, or to the rotor 72 of the electrical generator 14, as the means for starting the single-spool gas turbine engine 16.1, 16.1′, and could be used in addition to a hydraulic oil pump 70/gearbox 74.

It should be yet further understood that a starter motor 78/gearbox 74 can be used in addition to the hydraulic oil pump 70/gearbox 74, and both could share the same gearbox 74 that is operatively coupled either to the spool 38 of the single-spool gas turbine engine 16.1, 16.1′ or to the rotor 72 of the electrical generator 14 of an external auxiliary power unit (APU) 10, 10.1, 10.2, 10.3 incorporating a single-spool gas turbine engine 16.1, 16.1′, or, for an external auxiliary power unit (APU) 10, 10.1, 10.2, 10.3 incorporating a dual-spool gas turbine engine 16.1, 16.1″, operatively coupled to the first spool 38′ thereof. Alternatively, the starter motor 78 and hydraulic oil pump 70 could be operatively coupled via separate associated gearboxes, with the starter motor 78 operatively coupled either to the spool 38 or to the first spool 38′, and with the hydraulic oil pump 70 operatively coupled any of the other above-described locations of the powerplant 16, 16.1, 16.2 or the rotor 72 of the electrical generator 14.

It should be yet further understood that a single aircraft 12, 12′ could incorporate, or provide for incorporating, a plurality of external auxiliary power units (APU) 10, 10.1, 10.2, 10.3 of the same aspect, different aspects, or combinations thereof. Furthermore, it should be understood that notwithstanding that the external auxiliary power unit (APU) 10, 10.1, 10.2, 10.3 has been illustrated in cooperation with a military helicopter 12, 12′, the type of aircraft is not limiting, but in addition could include other types of helicopters or tilt-rotor aircraft; or fixed or variable-wing aircraft, with attachment thereto not limited to the wings thereof.

The first and second aspect external auxiliary power units (APU) 10, 10.1, 10.2 provide for attaching a self-contained auxiliary power unit (APU) to an existing hardpoint of an aircraft that can also be otherwise used to carry other payloads. The first and second aspect external auxiliary power units (APU) 10, 10.1, 10.2 can be readily attached to, or detached from, the aircraft 12, 12′ responsive to the requirements of a particular mission. Any of the first through third aspect external auxiliary power units (APU) 10, 10.1, 10.2, 10.3 can be used to provide supplemental power to the aircraft 12, 12′, for example, to provide supplemental electrical power that might be needed for a relatively-high-power Intelligence—Surveillance-Reconnaissance (ISR) mission package. The second and third aspect external auxiliary power units (APU) 10, 10.2, 10.3 provide for readily moving a self-contained auxiliary power unit (APU) to a remote camp and to generate power for the camp using fuel supplied by the aircraft 12, 12′, wherein the second aspect external auxiliary power unit (APU) 10, 10.2 can be disconnected from the aircraft 12, 12′ and connected to a stationary frame 128 with a fuel tank 130 to provide for continuing to deliver power without further need for the aircraft 12, 12′.

While specific embodiments have been described in detail in the foregoing detailed description and illustrated in the accompanying drawings, those with ordinary skill in the art will appreciate that various modifications and alternatives to those details could be developed in light of the overall teachings of the disclosure. It should be understood, that any reference herein to the term “or” is intended to mean an “inclusive or” or what is also known as a “logical OR”, wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. Furthermore, it should also be understood that the indefinite articles “a” or “an”, and the corresponding associated definite articles “the” or “said”, are each intended to mean one or more unless otherwise stated, implied, or physically impossible. Yet further, it should be understood that the expressions “at least one of A and B, etc.”, “at least one of A or B, etc.”, “selected from A and B, etc.” and “selected from A or B, etc.” are each intended to mean either any recited element individually or any combination of two or more elements, for example, any of the elements from the group consisting of “A”, “B”, and “A AND B together”, etc. Yet further, it should be understood that the expressions “one of A and B, etc.” and “one of A or B, etc.” are each intended to mean any of the recited elements individually alone, for example, either A alone or B alone, etc., but not A AND B together. Furthermore, it should also be understood that unless indicated otherwise or unless physically impossible, that the above-described embodiments and aspects can be used in combination with one another and are not mutually exclusive. Accordingly, the particular arrangements disclosed are meant to be illustrative only and not limiting as to the scope of the invention, which is to be given the full breadth of the appended claims, and any and all equivalents thereof.

What is claimed is:

1. An auxiliary power unit (APU) that is externally mountable to an aircraft, comprising:
a. a powerplant;
b. a particulate filter in fluid communication with or incorporated in an air inlet duct of said powerplant and in series with an inlet air flow to said powerplant when said powerplant is in operation;
c. a generator operatively coupled to and driven by said powerplant, wherein said auxiliary power unit (APU) is configured to operatively couple an electrical power output of said generator to at least one electrical-port power-connector, wherein said at least one electrical port power-connector provides for connecting to a mating electrical-port power-connector selected from the group consisting of a mating electrical-port power-connector of said aircraft and a mating electrical-port power-connector external of said aircraft;
d. a nacelle operatively surrounding said powerplant and said generator;
e. a hardpoint attachment interface, wherein said hardpoint attachment interface is operatively coupled to said powerplant, said generator and said nacelle, said hardpoint attachment interface provides for releasably coupling to a hardpoint of an aircraft, when said hardpoint attachment interface is coupled to said hardpoint of said aircraft, said hardpoint attachment interface provides for structurally coupling said powerplant, said generator and said nacelle to said aircraft external of said aircraft, and said hardpoint attachment interface provides for decoupling said powerplant, said generator and said nacelle from said aircraft; and
f. at least one fluid-port connector, wherein each fluid-port connector of said at least one fluid-port connector is in fluid communication with a corresponding associated element of said auxiliary power unit (APU) and provides for connecting to a corresponding mating fluid-port connector of at least one mating fluid-port connector of said aircraft so as to provide for communicating a corresponding associated fluid between said aircraft and said auxiliary power unit (APU), and said at least one fluid-port connector includes at least a fuel-port connector in fluid communication with said powerplant, wherein said fuel-port connector provides for connecting to a mating fuel-port connector of said aircraft so as to provide for supplying fuel from said aircraft to said powerplant for operation thereof.

2. An auxiliary power unit (APU) that is externally mountable to an aircraft as recited in claim 1, wherein said hardpoint attachment interface provides for coupling at least one said at least one fluid-port connector to a corresponding mating fluid-port connector of said aircraft.

3. An auxiliary power unit (APU) that is externally mountable to an aircraft as recited in claim 1, further comprising at least one other electrical-port connector, wherein each said at least one other electrical-port connector is in electrical communication with a corresponding associated element of said auxiliary power unit (APU) and provides for connecting to a corresponding at least one other mating electrical-port connector of said aircraft so as to provide for communicating a corresponding associated electrical power or communications signal between said aircraft and said auxiliary power unit (APU).

4. An auxiliary power unit (APU) that is externally mountable to an aircraft as recited in claim 3, wherein said hardpoint attachment interface provides for coupling at least one said at least one other electrical-port connector to a corresponding mating electrical-port connector of said aircraft.

5. An auxiliary power unit (APU) that is externally mountable to an aircraft as recited in claim 1, wherein said powerplant comprises a gas turbine engine.

6. An auxiliary power unit (APU) that is externally mountable to an aircraft as recited in claim 1, wherein a rotor of said generator is directly coupled to an output shaft of said powerplant.

7. An auxiliary power unit (APU) that is externally mountable to an aircraft as recited in claim 5, wherein a rotor of said generator is directly coupled to an output shaft of said gas turbine engine.

8. An auxiliary power unit (APU) that is externally mountable to an aircraft as recited in claim 1, wherein a rotor of said generator is coupled to an output shaft of said powerplant via a gearbox.

9. An auxiliary power unit (APU) that is externally mountable to an aircraft as recited in claim 1, wherein said generator comprises a permanent magnet generator incorporating a plurality of permanent magnets on a rotor of said permanent magnet generator.

10. An auxiliary power unit (APU) that is externally mountable to an aircraft as recited in claim 1, wherein said generator is an electrical generator selected from the group consisting of a synchronous AC generator, an asynchronous AC generator, a permanent magnet generator, a homopolar hybrid permanent magnet generator (HHPMG), a switched reluctance generator, an induction generator and a DC generator.

11. An auxiliary power unit (APU) that is externally mountable to an aircraft as recited in claim 1, further comprising at least one hydraulic machine selected from the group consisting of hydraulic pump driven by said powerplant and a hydraulic motor that provides for starting said powerplant, wherein a hydraulic inlet port of said at least one hydraulic machine is in fluid communication with a first hydraulic-fluid-port connector, a hydraulic outlet port of said at least one hydraulic machine is in fluid communication with a second hydraulic-fluid-port connector, said first hydraulic-fluid-port connector is a fluid-port connector selected from the group consisting of one of said at least one fluid-port connector and a first externally-accessible hydraulic-fluid-port connector that is accessible external of said aircraft, and said second hydraulic-fluid-port connector is a fluid-port connector selected from the group consisting of another of said at least one fluid-port connector and a second externally-accessible hydraulic-fluid-port connector that is accessible external of said aircraft.

12. An auxiliary power unit (APU) that is externally mountable to an aircraft as recited in claim 1, further comprising an air compressor that is either incorporated in or driven by said powerplant, wherein a pneumatic outlet port of said air compressor is in fluid communication with a pneumatic-fluid-port connector, said pneumatic-fluid-port connector is a fluid-port connector selected from the group consisting of one of said at least one fluid-port connector and an externally-accessible pneumatic-fluid-port connector that is accessible external of said aircraft.

13. An auxiliary power unit (APU) that is externally mountable to an aircraft as recited in claim 12, wherein said powerplant comprises a gas turbine engine, and said air compressor is provided for by a compressor of said gas turbine engine.

14. An auxiliary power unit (APU) that is externally mountable to an aircraft as recited in claim 5, wherein said gas turbine engine incorporates an oil cooler configured to receive a flow of air from either a fan or compressor of said gas turbine engine.

15. An auxiliary power unit (APU) that is externally mountable to an aircraft as recited in claim 1, wherein said particulate filter comprises an inertial particle separator within said inlet air flow.

16. An auxiliary power unit (APU) that is externally mountable to an aircraft as recited in claim 15, wherein said inertial particle separator comprises an air inlet duct of said nacelle having an outlet that is radially-outboard and axially aftward of an entrance to said air inlet duct of said powerplant.

17. An auxiliary power unit (APU) that is externally mountable to an aircraft as recited in claim 1, wherein said particulate filter comprises an air filter within said inlet air flow, wherein said air filter incorporates a filter media.

18. An auxiliary power unit (APU) that is externally mountable to an aircraft as recited in claim 1, wherein said powerplant comprises a diesel engine

19. An auxiliary power unit (APU) that is externally mountable to an aircraft as recited in claim 1, wherein said nacelle comprises:
a. a forward annular inlet so as to provide for a flow of a first portion of air into said powerplant, and
b. an aft outlet so as to enable a flow of second portion of said air through said nacelle around said powerplant and said generator.

20. An auxiliary power unit (APU) that is externally mountable to an aircraft as recited in claim 1, further comprising an electrical power converter, wherein an input of said electrical power converter is operatively coupled to an output of said generator, and an output of said electrical power converter is operatively coupled to said at least one electrical-port power-connector, and said electrical power converter provides for an electrical power conversion process selected from the group consisting of a conversion from AC to DC, a conversion from DC to AC and a power conditioning process.

21. An auxiliary power unit (APU) that is externally mountable to an aircraft as recited in claim 1, further comprising an APU external interface that provides for coupling at least one said at least one fluid-port connector to a corresponding mating fluid-port connector external of said aircraft.

22. An auxiliary power unit (APU) that is externally mountable to an aircraft as recited in claim 1, further comprising at least one other electrical-port connector, wherein each said at least one other electrical-port connector is in electrical communication with a corresponding associated element of said auxiliary power unit (APU) and provides for connecting to a corresponding at least one other mating electrical-port connector of an APU external interface so as to provide for communicating a corresponding associated electrical power or communications signal between said auxiliary power unit (APU) and said corresponding at least one other mating electrical-port connector of said APU external interface.

23. An auxiliary power unit (APU) that is externally mountable to an aircraft as recited in claim 22, wherein said APU external interface provides for initiating the operation of said powerplant from a location external of said aircraft and external of said auxiliary power unit (APU).

24. An auxiliary power unit (APU) that is externally mountable to an aircraft as recited in claim 21, wherein said APU external interface provides for initiating the operation of said powerplant from a location external of said aircraft and external of said auxiliary power unit (APU).
